(19) United States
(12) Patent Application Publication
(10) Pub. No.: US 2014/0108413 A1
(43) Pub. Date: Apr. 17, 2014

(54) Responsive Images Service

(71) Applicant: DELL PRODUCTS L.P., Round Rock, TX (US)

(72) Inventor: Luis J. Botero, Austin, TX (US)

(73) Assignee: DELL PRODUCTS L.P., Round Rock, TX (US)

(21) Appl. No.: 13/649,521

(22) Filed: Oct. 11, 2012

(51) Int. Cl. G06F 17/30

(52) U.S. Cl. 707/741; 707/E17.002; 707/E17.019

(57) ABSTRACT

A system, method, and computer-readable medium are disclosed for automating the management of a device description repository (DDR). A device properties detection script embedded in a web page is executed when the web page is processed by a browser. Upon execution, the embedded script determines various properties associated with the user's device, which are then provided along with the device's user-agent identifier for processing. In turn, the provided user-agent identifier is used to search a predetermined DDR for a matching user-agent identifier. If a matching user-agent identifier is not found, then the provided user-agent identifier and its corresponding device properties are stored in the DDR. The device properties associated with the user-agent identifier are then used to initiate the provision of device-optimized images to the browser.

### BACKGROUND OF THE INVENTION

1. Field of the Invention

The present invention relates to the management of information handling systems. More specifically, embodiments of the invention provide a system, method, an computer-readable medium for automating the management of a device description repository (DDR).

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Today's information handling systems are available in a myriad of form factors, computing power, communication capabilities, screen sizes and resolutions. As a result, providing an optimal viewing experience, which includes displaying graphical content with a minimum of resizing, panning and scrolling across a wide variety of devices, can prove challenging.

One approach to this issue is responsive images, which refers to the concept of delivering device-optimized images for mobile and non-mobile websites. However, existing approaches have corresponding limitations. For example, the Hypertext Mark-up Language (HTML) specification defines an image (IMG) tag, which only allows the specification of a single source for an image. Another approach is Cascading Style Sheet (CSS) images, which can use media queries to provide different image sources based upon screen size. Certain of these client-side approaches rely upon adjusting the image source attribute dynamically via JavaScript. However, these approaches have attendant challenges such as creating a race condition as JavaScript needs to run before image requests start and that behavior varies among browsers. Additionally, these client-side solutions are largely dependent upon the current behavior of today's browsers. As a result, they are not particularly future-proof as the current page mark-up would have to be modified to accommodate future standards.

Alternatively, server-side approaches use user-agent strings to make decisions on which images to serve. Server-side detection for provision of responsive images is fast, accurate, reliable and imposes the least burden upon the device. It is also future-proof, as it does not require markup to be adapted to support future browser changes. However, server-side approaches rely upon a database of user agent-strings, and corresponding device features, such as screen dimensions and resolution, communication support, Geographical Positioning System (GPS) support, and so forth. These databases, which typically reside in a Device Description Repository (DDR) such as Wireless Universal Resource File (WURFL) and OpenDDR, rely upon the developer community to keep up with the constant updates and additions of new devices. However, manually maintaining a DDR is time consuming. Furthermore, relying upon a community-supported DDR represents potential risk and could result in the incurrence of licensing fees that are economically unfeasible.

### SUMMARY OF THE INVENTION

A system, method, and computer-readable medium are disclosed for automating the management of a device description repository (DDR). In various embodiments, automated DDR management operations are initiated when a browser loads a web page containing an embedded device properties detection script, which in turn is executed when the web page is processed by the browser. Upon execution, the embedded script determines various properties associated with the user's device. In these and other embodiments, the associated device properties may comprise the dimensions of the device's display, the resolution of its display, its communications capabilities, and its data processing capabilities.

Once determined, the device's user-agent identifier and its associated properties are then provided to an automated DDR management system. In various embodiments, the browser provides the user-agent identifier and the embedded device properties detection script provides the device's associated properties. In turn, the provided user-agent identifier is used to search a predetermined DDR for a matching user-agent identifier. If a matching user-agent identifier is not found, then the user-agent identifier is stored with its corresponding device properties in the DDR. In various embodiments, indexing operations are performed to cross-reference the user-agent identifier and the corresponding client device properties before they are stored in the DDR.

However, if a matching user-agent identifier is found in the DDR, then a determination is made whether their respective, associated device properties match. If not, then a determination is made whether to revise the device properties corresponding to the matching user-agent identifier. If so, then the device properties corresponding to the matching user-agent identifier are revised in the DDR. In various embodiments, the device properties associated with the user-agent identifier are then used to initiate the provision of device-optimized images to the browser.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the system and method of the present invention;

FIG. 2 is a simplified block diagram showing the performance of responsive image management operations;

FIG. 3 is a generalized flowchart of the performance of automated Device Description Repository (DDR) management operations; and

FIG. 4 is a generalized flowchart of the performance of responsive image management operations.

### DETAILED DESCRIPTION

A system, method, and computer-readable medium are disclosed for automating the management of a device description repository (DDR). For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

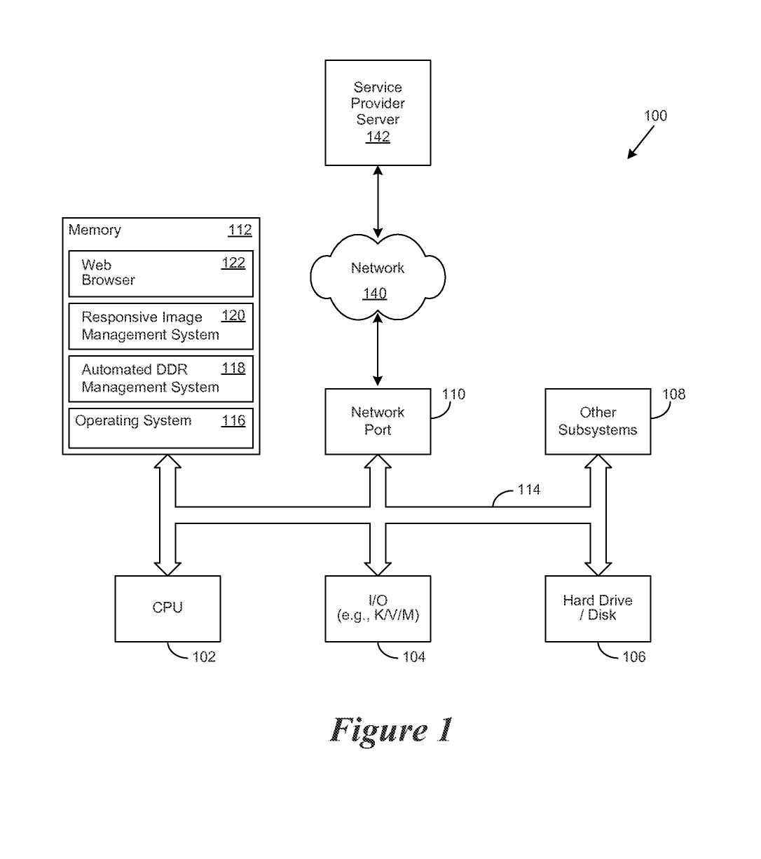

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise an automated device description repository (DDR) management system 118, a responsive image management system 120, and a web browser 122. In one embodiment, the information handling system 100 is able to download the automated DDR management system 118 and the responsive image management system 120 from the service provider server 142. In another embodiment, the automated DDR management system 118 and the responsive image management system 120 is provided as a service from the service provider server 142.

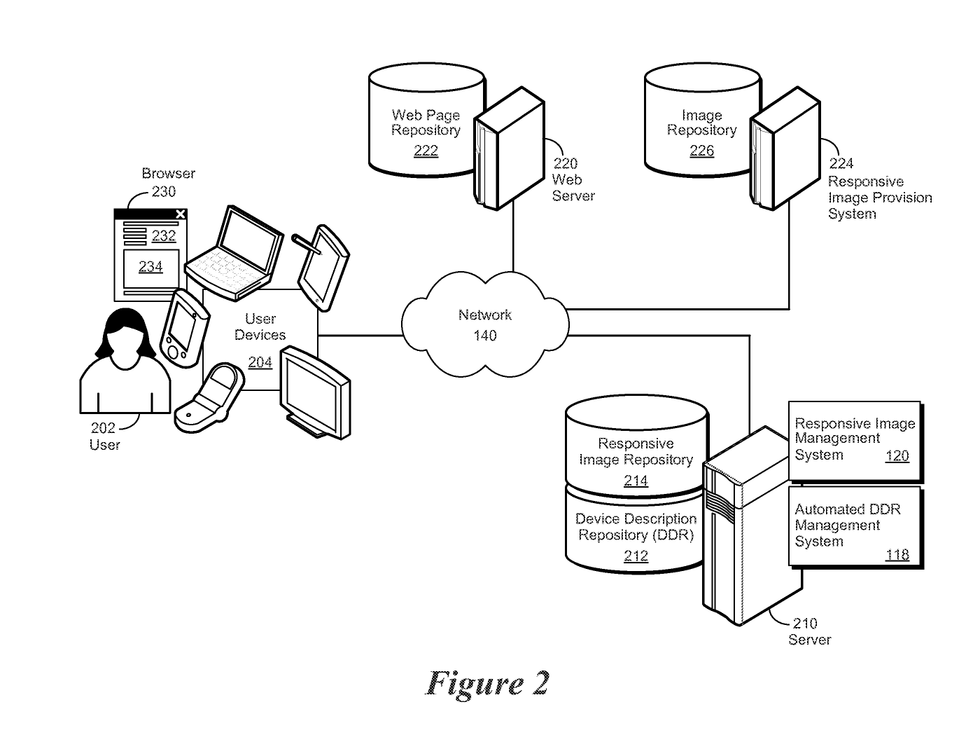

FIG. 2 is a simplified block diagram showing the performance of automated device description repository (DDR) management operations as implemented in accordance with an embodiment of the invention. In various embodiments, an automated DDR management system 118 is implemented to automate the management of a DDR 212. In these and other embodiments, the automated DDR management system 118 may be implemented on one or more servers 210, which are connected to network 140. In various embodiments, the network 140 may comprise a public network, such as the Internet, a physical private network, a virtual private network (VPN), or any combination thereof.

As used herein, a DDR 212 broadly refers to a repository of data associated with the properties of a target device, such as user devices 204. In various embodiments, these properties may comprise the dimensions of a user device's 204 display, the resolution of its display, its sensorial capabilities, its communications capabilities, and its data processing capabilities. Those of skill in the art will recognize that a user device 204 may comprise many such associated properties and the foregoing is not intended to limit the spirit, scope or intent of the invention. In various embodiments a user device 204 may comprise a personal computer, a laptop computer, a tablet computer, a personal digital assistant (PDA), a mobile telephone, a wearable device, etc., configured for use by a user 202. In these and other embodiments, the user device 204 is operable to establish an on-line session with the automated DDR system 118, a responsive image management system 120, a responsive image provision system 224, or a web server 220 over a connection to network 140.

Referring now to FIG. 2, automated DDR management operations are initiated when a browser 230 implemented on a client device 204 loads a web page 232 that contains an embedded device properties detection script. The web page 232 is then processed by the browser 230, resulting in the execution of the embedded script, which in turn determines various properties associated with the user's device 204. The user device's 204 user-agent identifier and its associated properties are then provided to the automated DDR management system 118. In various embodiments, the browser 230 provides the user-agent identifier and the embedded device properties detection script provides the user device's 204 associated properties. As used herein, a user-agent identifier broadly refers to any identification information, implicit or explicit (e.g., a user-agent string), that can be used to identify the client software originating the request.

The provided user-agent identifier is then used by the automated DDR management system 118 to search for a matching user-agent identifier in the DDR 212. If a matching user-agent identifier is not found, then the user-agent identifier is stored with its corresponding user device 204 properties in the DDR 212. In various embodiments, indexing operations are performed to cross-reference the user-agent identifier and the corresponding user device 204 properties before they are stored in the DDR 212. However, if a matching user-agent identifier is found in the DDR 212, then a determination is made whether their respective, associated user device 204 properties match. If not, then a determination is made whether to revise the user device 204 properties corresponding to the matching user-agent identifier. If so, then the user device 204 properties corresponding to the matching user-agent identifier are revised in the DDR 212.

In various embodiments, responsive image management operations are initiated by a browser 230 loading a web page 232 that requires a target image 234. In these and other embodiments, the web page is retrieved from a web page repository 22 and then provided to the browser 230 by a web server 220. The browser's 230 user-agent identifier (e.g., a user-agent string) and a request for the target image 234 are then received by the responsive image management system 120. In turn, the responsive image management system 120 then searches the DDR 212 for a matching user-agent identifier.

If a matching user-agent identifier is found in the DDR 212, then the provided user-agent identifier is used to search a responsive image repository 214 for a corresponding image. If a corresponding responsive image was not found in the responsive image repository 214, or if a matching user-agent identifier was not found in the DDR 212, then user device 204 properties associated with the provided user-agent identifier are provided to a responsive image provision system 224. In one embodiment, the associated user device 204 properties reside in the DDR 212. In another embodiment, the user device 204 properties are provided, as described in greater detail herein, by an embedded device properties detection script.

The responsive image provision system 224 then processes the user device 204 properties to generate a responsive image. In one embodiment, the responsive image is generated from a source image stored in an image repository 226. In another embodiment, a responsive image compatible with the provided user device 204 properties has already been generated and is already stored in the image repository 226. In turn, the responsive image is provided to the responsive image management system 120, which then saves it to the responsive image repository 214. Thereafter, or if a corresponding responsive image was found in the responsive image repository 214, the responsive image is provided to the browser 230.

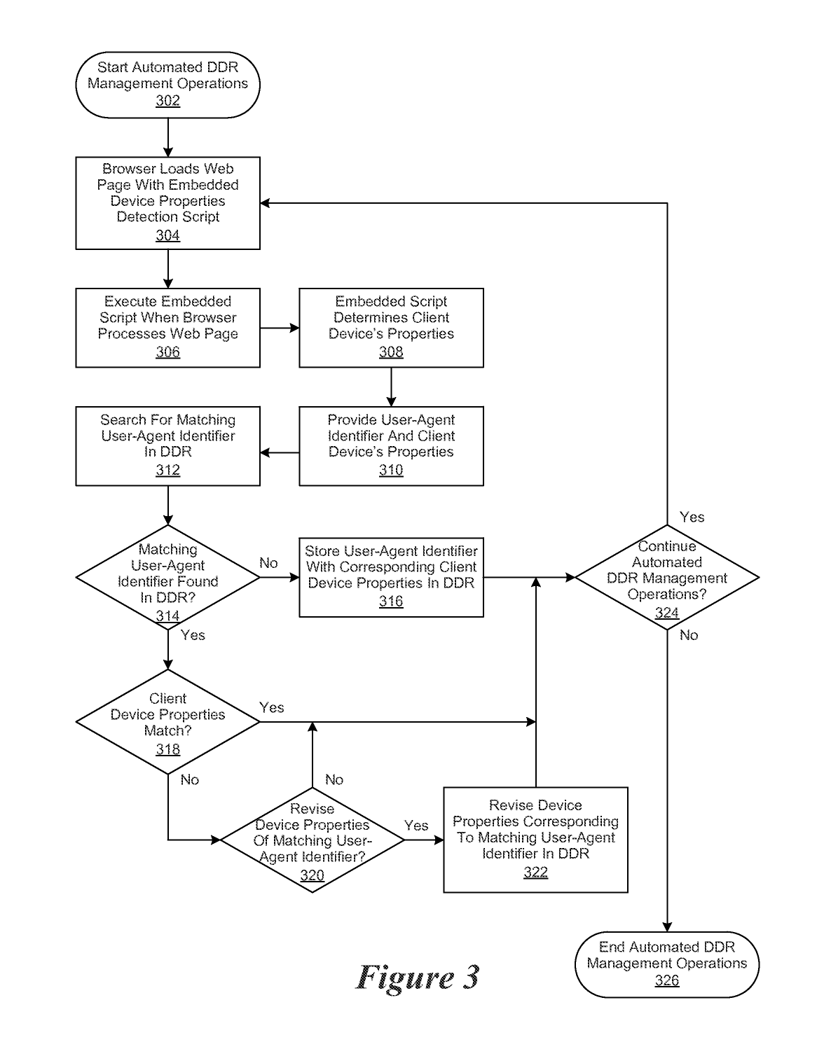

FIG. 3 is a generalized flowchart of the performance of automated device description repository (DDR) management operations in accordance with an embodiment of the invention. In this embodiment, automated DDR management operations are begun in step 302, followed by a browser implemented on a client device loading a web page that contains an embedded device properties detection script in step 304. The browser then processes the web page in step 306, resulting in the execution of the embedded script, which in turn determines various properties associated with the client device in step 308.

The client device's user-agent identifier and its associated properties are then provided to an automated DDR management system in step 310. The provided user-agent identifier is then used by the automated DDR management system to search for a matching user-agent identifier in an associated DDR in step 312. A determination is then made in step 314 whether a matching user-agent identifier is found in the DDR. If not, then the user-agent identifier is stored with its corresponding client device properties in step 316. A determination is then made whether to continue automated DDR management operations in step 324. If so, then the process is continued, proceeding with step 304. Otherwise, automated DDR management operations are ended in step 326.

However, if it is determined in step 314 that a matching user-agent identifier is found in the DDR, then a determination is made in step 318 whether their respective, associated client device properties match. If so, then the process is continued, proceeding with step 324. Otherwise, a determination is made in step 320 whether to revise the client device properties corresponding to the matching user-agent identifier. If not, then the process is continued, proceeding with step 324. Otherwise the client device properties corresponding to the matching user-agent identifier are revised in the DDR in step 322. The process is then continued, proceeding with step 324.

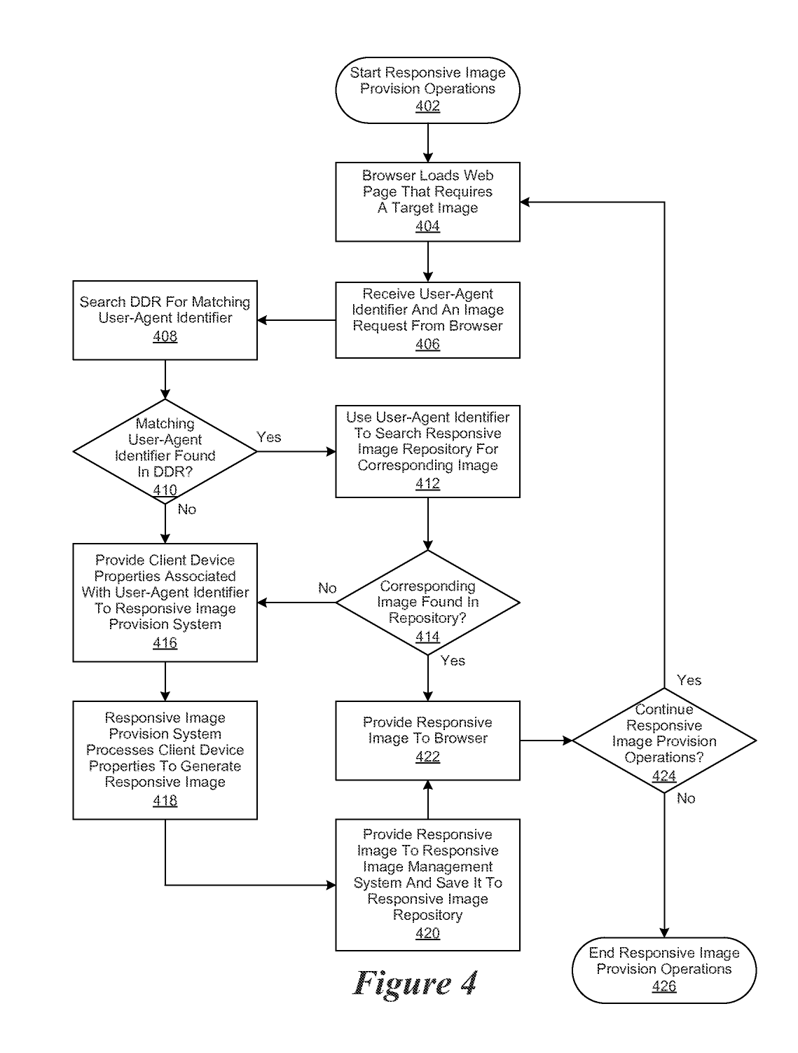

FIG. 4 is a generalized flowchart of the performance of responsive image management operations in accordance with an embodiment of the invention. In this embodiment, responsive image provision operations are begun in step 402, followed by a browser loading a web page that requires a target image in step 404. The browser's user-agent identifier (e.g., a user-agent string) and a request for the target image are then received in step 406 by a responsive image management system. In turn, the responsive image management system then searches a device description repository (DDR) in step 4408 for a matching user-agent identifier.

A determination is then made in step 410 whether a matching user-agent identifier is found in the DDR. If so, then the provided user-agent identifier is used in step 412 to search a responsive image repository for a corresponding image. A determination is then made in step 414 whether a corresponding responsive image was found in the responsive image repository. If not, or if it was determined in step 410 that a matching user-agent identifier was not found in the DDR, then client device properties associated with the provided user-agent identifier are provided to a responsive image provision system in step 416.

Then, in step 418, the responsive image provision system processes the client device properties to generate a responsive image. In turn, the responsive image is provided in step 420 to the responsive image management system, which then saves it to the responsive image repository. Thereafter, or if it was determined in step 414 that a corresponding responsive image was found in the responsive image repository, the responsive image is provided to the browser in step 422. A determination is then made in step 424 whether to continue responsive image provision operations. If so, then the process is continued, proceeding with step 404. Otherwise, responsive image provision operations are ended in step 426.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art wilt recognize that the separation of functionality into modules is for illustrative purposes. Alternative embodiments may merge the functionality of multiple modules into a single module or may impose an alternate decomposition of functionality of modules. For example, a software module for sub-modules may be decomposed on that each sub-module performs its function and passes control directly to another sub-module.

Consequently, the invention is intended to be limited only by the spirit and scope of the appended claims, giving full cognizance to equivalents in all respects.

What is claimed is:

1. A computer-implementable method for automating the management of a device description repository (DDR), comprising:
receiving a first user-agent identifier and a request for a first image;
receiving a first set of device properties associated with the first user-agent identifier;
using the first user-agent identifier to search the DDR for a second user-agent identifier, the first user-agent identifier matching the second user-agent identifier;
processing the first set of device parameters to initiate the provision of the first image if the second user-agent identifier is not found, the first image compatible with the first set of device properties;
indexing the first user-agent identifier to the first set of device properties and to the first image; and
storing the indexed first user-agent identifier and the first set of device properties in the DDR.

2. The method of claim 1, wherein:
the first user-agent identifier and the request for the first image is received from a web browser processing a web page; and
the first set of device properties is provided by a device detection script embedded in the web page, the execution of the device detection script initiated by the processing of the web page by the web browser.

3. The method of claim 1, wherein:
the second user-agent identifier is found in the DDR; and
the second user-agent identifier is associated with a second set of device properties stored in the DDR.

4. The method of claim 3, wherein:
the first and second sets of device parameters do not match each other; and
the first and second sets of device properties are processed to generate revisions to the second set of device properties.

5. The method of claim 4, wherein:
the revised second set of device properties is processed to initiate the provision of a second image compatible with the revised second set of device properties; and
the second image is provided in response to the request for the first image.

6. The method of claim 1, wherein the first set of device properties comprises at least one of the set of:
the dimensions of the device's display;
the resolution of the device's display;
the communication capabilities of the device; and
the data processing capabilities of the device.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for automating the management of a device description repository (DDR) and comprising instructions executable by the processor and configured for:
receiving a first user-agent identifier and a request for a first image;
receiving a first set of device properties associated with the first user-agent identifier;
using the first user-agent identifier to search the DDR for a second user-agent identifier, the first user-agent identifier matching the second user-agent identifier;
processing the first set of device parameters to initiate the provision of the first image if the second user-agent identifier is not found, the first image compatible with the first set of device properties;
indexing the first user-agent identifier to the first set of device properties and to the first image; and
storing the indexed first user-agent identifier and the first set of device properties in the DDR.

8. The system of claim 7, wherein:
the first user-agent identifier and the request for the first image is received from a web browser processing a web page; and
the first set of device properties is provided by a device detection script embedded in the web page, the execution of the device detection script initiated by the processing of the web page by the web browser.

9. The system of claim 7, wherein:
the second user-agent identifier is found in the DDR; and
the second user-agent identifier is associated with a second set of device properties stored in the DDR.

10. The system of claim 9, wherein:
the first and second sets of device parameters do not match each other; and
the first and second sets of device properties are processed to generate revisions to the second set of device properties.

11. The system of claim 10, wherein:
the revised second set of device properties is processed to initiate the provision of a second image compatible with the revised second set of device properties; and
the second image is provided in response to the request for the first image.

12. The system of claim 7, wherein the first set of device properties comprises at least one of the set of:
the dimensions of the device's display;
the resolution of the device's display;
the communication capabilities of the device; and
the data processing capabilities of the device.

13. A non-transitory, computer-readable storage medium embodying computer program code, the computer program code comprising computer executable instructions configured for:
receiving a first user-agent identifier and a request for a first image;
receiving a first set of device properties associated with the first user-agent identifier;
using the first user-agent identifier to search the DDR for a second user-agent identifier, the first user-agent identifier matching the second user-agent identifier;
processing the first set of device parameters to initiate the provision of the first image if the second user-agent identifier is not found, the first image compatible with the first set of device properties;
indexing the first user-agent identifier to e first set of device properties and to the first image; and
storing the indexed first user-agent identifier and the first set of device properties in the DDR.

14. The non-transitory, computer-readable storage medium of claim 13, wherein:
the first user-agent identifier and the request for the first image is received from a web browser processing a web page; and
the first set of device properties is provided by a device detection script embedded in the web page, the execution of the device detection script initiated by the processing of the web page by the web browser.

15. The non-transitory, computer-readable storage medium of claim 13, wherein:
the second user-agent identifier is found in the DDR; and
the second user-agent identifier is associated with a second set of device properties stored in the DDR.

16. The non-transitory, computer-readable storage medium of claim 15, wherein:
the first and second sets of device parameters do not match each other; and
the first and second sets of device properties are processed to generate revisions to the second set of device properties.

17. The non-transitory, computer-readable storage medium of claim 16, wherein:
the revised second set of device properties is processed to initiate the provision of a second image compatible with the revised second set of device properties; and
the second image is provided in response to the request for the first image.

18. The non-transitory, computer-readable storage medium of claim 13, wherein the first set of device properties comprises at least one of the set of:
the dimensions of the device's display;
the resolution of the device's display;
the communication capabilities of the device; and
the data processing capabilities of the device.
